(19) United States
(12) Patent Application Publication
(10) Pub. No.: US 2019/0088074 A1
(43) Pub. Date: Mar. 21, 2019

(54) SYSTEM AND METHOD OF COMBINING A LOTTERY GAME AND A TABLE

(71) Applicant: Lance Lietzau, Hopkins, MN (US)

(72) Inventor: Lance Lietzau, Hopkins, MN (US)

(21) Appl. No.: 15/782,445

(22) Filed: Oct. 12, 2017

Related U.S. Application Data
(60) Provisional application No. 62/561,029, filed on Sep. 20, 2017.

(51) Int. Cl. G07F 17/32; A63F 3/00; A63F 3/06

(52) U.S. Cl. CPC G07F 17/329; A63F 3/00157; G07F 17/3211; A63F 3/0605; G07F 17/3269; G07F 17/3223

(57) ABSTRACT

A system and method of combining a lottery game and a table game includes a plurality of table games each including a plurality of player positions. A plurality of interface assemblies is provided and each has one of the interface assemblies. Each of the interface assemblies is programmed to receive one or more betting units from each of the plurality of player positions and associating the betting units with each player position submitting the betting units. A database is in communication with each of the interface assemblies. The database is programmed to tally the betting units and form a pool of the betting units. The database is programmed to randomly select one of the betting units to define a winning bet and communicating the winning bet and the pool to at least the interface assembly positioned on the table game associated with the player position having the winning bet.

### CROSS-REFERENCE TO RELATED APPLICATIONS

I hereby claim the benefit under 35 U.S.C. Section 119(e) of U.S. Provisional application 62/561,029 filed on Sep. 20, 2017.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to lottery game systems and more particularly pertains to a new lottery game system for allowing a plurality of players playing a first game, such as a table card game, to also intermittently and selectively wager on a second game comprising a lottery draw between participating players of the second game.

### BRIEF SUMMARY OF THE INVENTION

An embodiment of the disclosure meets the needs presented above by generally comprising a plurality of table games. Each of the table games includes a plurality of player positions. A plurality of interface assemblies is provided and each of the table games has one of the interface assemblies. Each of the interface assemblies is programmed to receive one or more betting units from each of the plurality of player positions and associating the betting units with each player position submitting the betting units. A database is in communication with each of the interface assemblies. The database is programmed to tally the betting units and form a pool of the betting units. The database is programmed to randomly select one of the betting units to define a winning bet and communicating the winning bet and the pool to at least the interface assembly positioned on the table game associated with the player position having the winning bet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a schematic view of a system and method of combining a lottery game and a table game according to an embodiment of the disclosure.

FIG. 2 is a schematic view of a plurality of table games of an embodiment of the disclosure.

FIG. 3 is a front view of an interface assembly of an embodiment of the disclosure.

FIG. 4 is a schematic view of an embodiment of the disclosure.

FIG. 5 is a schematic view of an embodiment of the disclosure.

### DETAILED DESCRIPTION OF THE INVENTION

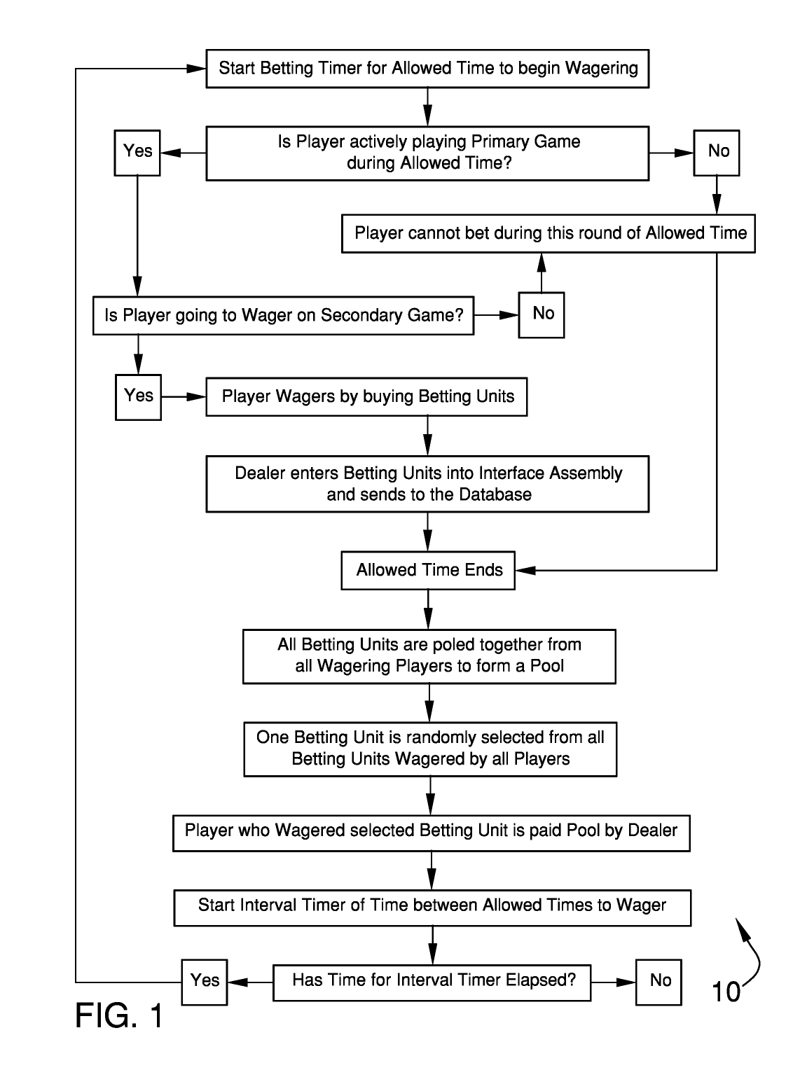

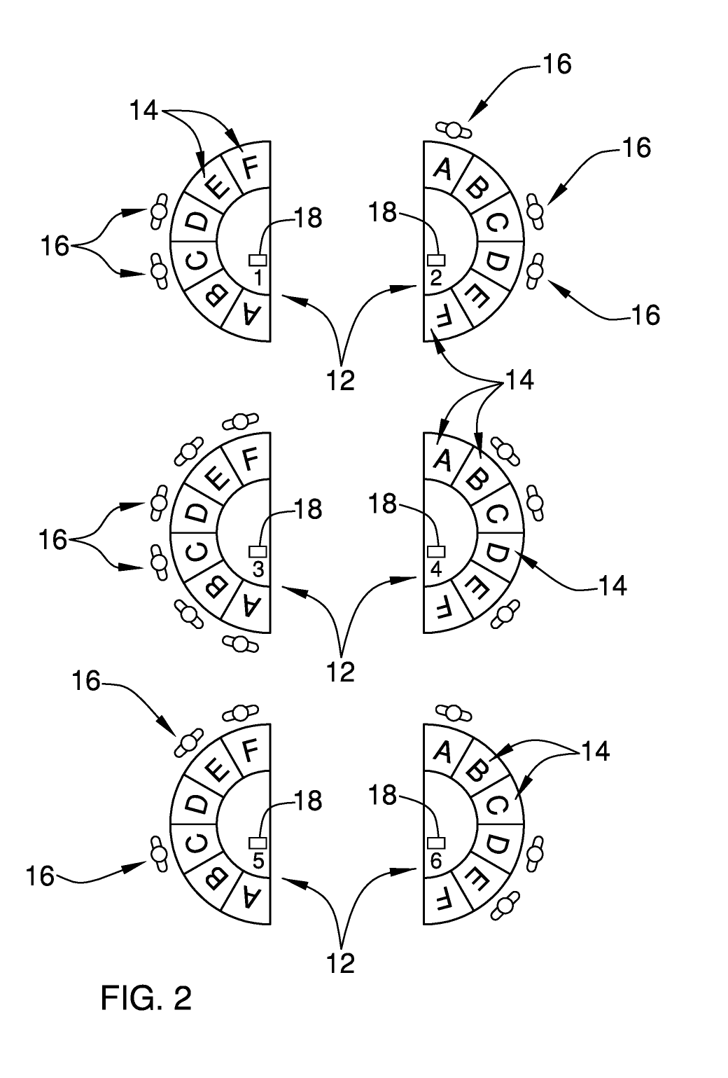

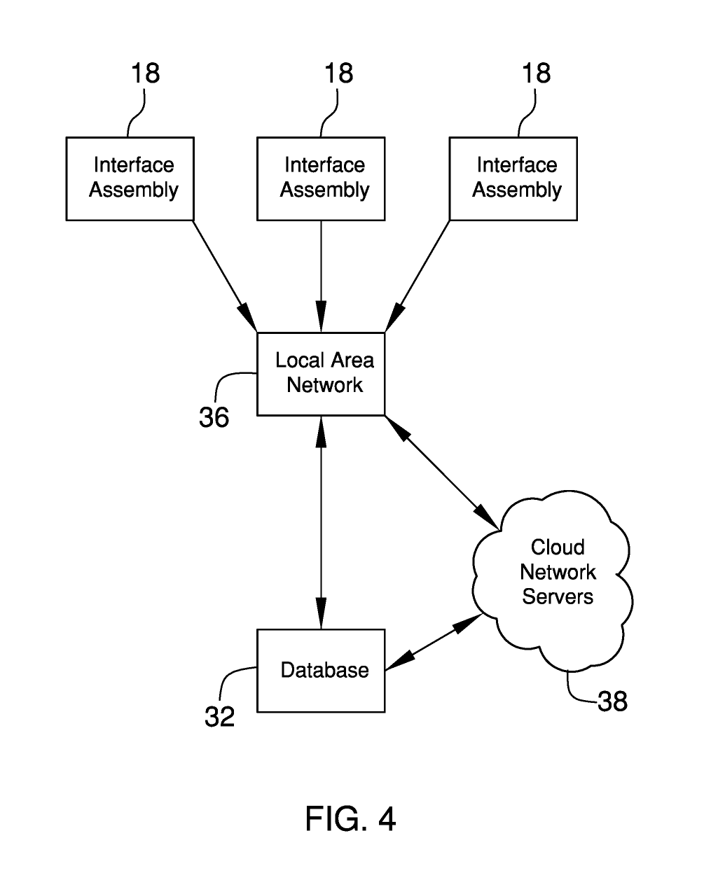

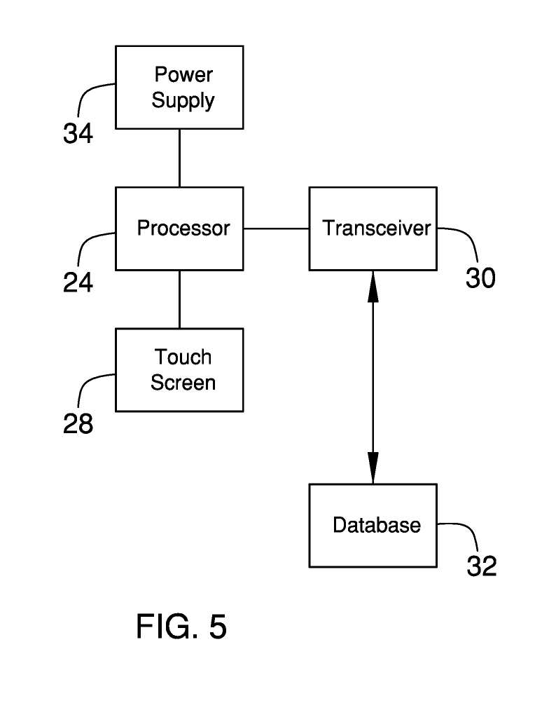

With reference now to the drawings, and in particular to FIGS. 1 through 5 thereof, a new lottery game system embodying the principles and concepts of an embodiment of the disclosure and generally designated by the reference numeral 10 will be described.

As best illustrated in FIGS. 1 through 5, the system 10 and method of combining a lottery game and a table game generally comprises a system 10 that is designed, in particular, to be played with a plurality of table games 12. Table games 12 are ubiquitous in casinos and each typically includes one primary game that is played by players seated at player positions 14. While a single player may utilize a plurality of player positions 14, a lottery game, as discussed herein, is not dependent upon the player position 14 for betting purposes but is simply utilized to locate the player 16 who is the winner of the lottery game. The table games 12 may comprise any number of common casino games including, for example, various card games, roulette, craps, pai gow and the like. However, the system 10 is most typically well suited for those games involving one or more decks of cards such as poker, baccarat, blackjack and the multiple derivatives of those two games. Generally, for the purpose of the system 10, players 16 will typically only be allowed to bet on the lottery game if they are also playing the primary game such that their player position 14 may be defined as an active position wherein they are at least wagering on the primary game which they will play in a conventional manner.

A plurality of interface assemblies 18 is provided and each table game 12 within the overall lottery game will include one of the interface assemblies 18. The interface assemblies 18 are to be used to play a second game, or lottery game, between players who desire to play such while also playing the primary game. The lottery game is generally conventional in that each willing player 16 will buy a desired number of plays within the lottery game. One player 16 may, for instance, buy five plays while the next player 16 only buys 1 play. The more plays a player buys, or wagers, the greater the chance to win. As an example, if a pool contains one hundred plays, and a player 16 buys 10 plays, that player would have a 1 in 10 chance of winning the lottery game. The players 16 will have the option to wager as many plays as they chose (within casino appointed limits) or to not play at all.

The interface assemblies 18 may be embedded into a surface of its associated table game 12 though it may be beneficial to allow the interface assemblies 18 to be detached or detachable from the table games 12 so that they can be moved to different table games 12 as needed. In this manner, while a casino might have forty table games 12, a smaller number of interface assemblies 18 may utilized as not all table games 12 within the casino need be part of the lottery game. Moreover, this will allow a casino floor manager to move the interface assemblies 18 to table games 14 having a higher number of active positions. The interface assemblies 18 may be programmed such that they are assigned to a particular gaming table 12 and that assignation is changed when the interface assembly 18 is moved to a different gaming table 12 so that each interface assembly 18 is always associated with the table game 12 and player positions 14 it is being used with.

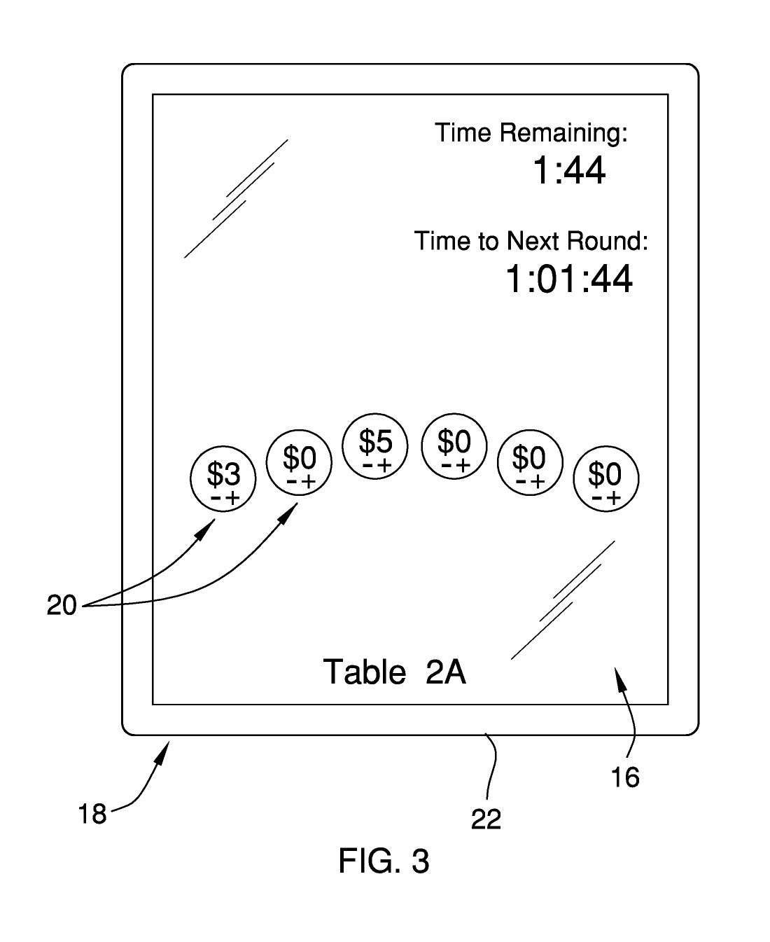

Each of the interface assemblies 18 is programmed to receive one or more betting units from each of the plurality of player positions 14 and associating the betting units with each player position 14 submitting the betting units. As can be seen in FIG. 3, a specific input location 20 may exist for each player position 14. The term “betting units” is being utilized as each betting unit is discrete with respect to each other and are monetarily equal to each other. For example, a single betting unit may be equal to a monetary amount such as $1, $5, $10 and onward. However, the casino may decide to award players 16 who are playing the primary game with betting units in the form of electronic awards or award markers/chips. If the minimum wager for the second game is $1 per play and a player wagers $4, that player 16 will have purchased four betting units. Furthermore, the betting units are each differentiated from each other as each is associated with one of the player positions on the table game 12. Typically, in table games 12, the player's wagers are placed in front of them while gameplay takes place for the primary game. For the second game, and unlike table games 12, the wagers will typically be collected and removed from the table game 12 once placed and therefore the betting units must be tracked when placed. To that end, the interface assemblies 18 associate the betting units with the player positions 14 from which they came.

The interface assemblies 18 will typically include a housing 22 and a processor 24 that is mounted within the housing 22. An input 26 is mounted on the housing 22 and is electrically coupled to the processor 24. The input 26 is actuatable to input a number of the betting units associated with each of the player positions 14 at an associated one of the table games 12. Preferably the input may comprise a touchscreen 28. A touchscreen 28 can be utilized to visually display the number of betting units played by each player 16, the amount the winner player will win as well as the winner bet and the player position 14 associated with the winning bet. The interface assembly 18 may further include a transceiver 30 for wireless communication with other interface assemblies 18 or with a database 32. The transceiver 30 is mounted within the housing 22 and electrically coupled to the processor 24. The interface assembly 18, as described above, may be what is conventionally known as an electronic tablet. A power supply 34 may include a battery mounted within the housing 22 though it is preferred that each table game 12 include a power outlet to ensure power is not lost during gameplay.

The database 32 is in communication with each of the interface assemblies 18. It should be understood that the database 32 may be comprised of one of interface assemblies 18 or may comprise a separate computing assembly that may be positioned within the same casino complex with the interface assemblies 18 or placed offsite and in wired or wireless communication with a server that is in communication with each of the interface assemblies 18. However, when the second game is played, the betting will take place only between those persons located within a same casino complex, i.e. building, to increase the excitement amongst players who are in more intimate proximity with respect to each other. Consequently, while the database 32 may be programmed to receive and process data from a plurality of casino complexes, each casino complex would be handled independently from the other casino complexes by the database 32.

Communication between the database 32 and the interface assemblies 18 may be accomplished in any conventional manner. The database 32 may be wired or wirelessly in communication for local area network (LAN) 36 which is in wireless communication with each of the interface assemblies 18. The interface assemblies 18 may communicate with an internet router, likely by wireless communication that connects with a cloud server network 38. Thereafter the cloud server network 38 may communicate with the database 32, though a wired or wireless router may simply by itself or in connection with the LAN 36 be in communication with the database 32. Thus, the database 32 may be placed most convenient to the operator of the system 10.

The database 32 is programmed to tally the betting units and form a pool of the betting units. The pool is the amount of money that will paid out to the winner of the second game but the pool will typically not be equal to the total number betting units and will instead usually be less than the total of betting units. The casino will determine a percentage that will paid to the winner player and a percentage that will be retained by the casino as profit. The database 32 will be programmed to determine the amount retained. As an example, if a 100 betting units are wagered and each betting unit is $2, the pool may be equal to $180 if the casino retains 10% of wagered bets. The database 32 will also be programmed to calculate retained taxes should a player win a pool that large enough to trigger a taxable event.

The betting units may be assigned a unique identifier by the interface assembly or the database 32, though the betting units may be synonymous with the unique identifier. The unique identifier includes information related to who placed the wager and more specifically the player position 14 or active position. The database 32 is programmed to randomly select one of the betting units, or the unique identifier, to define a winning bet and thereafter communicate the winning bet and the pool to at least the interface assembly positioned on the table game 12 associated with the player position having the winning bet.

Example of Gameplay:

A plurality of players 16 are seated at various table games 12 each having its own input assembly. Each player 16 is also positioned at player position 14 and are wagering on the primary games for their game table 12 so that their player position 16 is an active position that thereby qualifies the player 16 for the second game. At predetermined intervals, the active positions are offered the opportunity to play the second game. The predetermined intervals are typically greater than 30 minutes and less than 3 hours. This will provide for a large number of added game experiences for the players 16 without distracting from the primary game. Furthermore, the presentation to the players 16 to play the second game will last for only a predetermined amount of time which will typically be less than 5 minutes and more particularly less than 3 minutes to again prevent prolonged interference with the primary game. Either the database 32 or the input assemblies 18 may be programmed to track the predetermined intervals and amount of time to place bets. The predetermined intervals and amount of time to place bets may both be readily viewable to the players 16 as a countdown clock that may be displaced on the interface assemblies 18 or displayed remotely from the table games 12 such as a display on a wall or mounted in a conspicuous area where it can be viewed by multiple ones of the table games 12.

During the predetermined amount of time, the dealer of the primary game will accept wagers, defined generally herein as betting units, for the second game. The players 16 essentially are playing against each other in a drawing and the more betting units waged, the greater their chances of winning. The dealer will enter the amount that each player bets so that each player playing this second game will be credited their betting units. The player 16 will be able to pay down to a minimum amount allowed for that particular table game 12 and up a maximum amount allowed for that table game 12. The minimums and maximums may be tied to the minimum and maximums of the primary game but this need not be the case.

After the predetermined amount of time has elapsed, the interface assemblies 18 send the betting unit data to the database 32 which assigns each betting unit its unique identifier, if the betting unit is already itself not the unique identifier, and then randomly selects one of the unique identifiers to define a winning bet. As can be seen in the Figures, the table games 12 may be numbered 1 through 6, each having a player position marked A through F. As a non-limiting example shown in FIG. 3, a player 16 seated at 2A places 3 bets may have betting units having unique identifiers 2A1, 2A2 and 2A3, indicating the player at position 2A has made bets 1, 2 and 3. The database 32 may receive information that from the interface assembly 18 on table 2 that player A has made three bets and thereafter may assign unique identifications that are then back associated to the player 16 should that player win. The above is example only and any conventional manner of assigning a player 16 a particular player position 14 and unique identifier per bet or betting unit may be utilized.

The database 32 also calculates, as stated above, the pool that will be paid out to a winner of the second game. The database 32 transmits the pool amount and winning bet associated therewith and defined as the winning player to the interface assemblies 18 though only the interface assembly 18 associated with the winning player need be sent this information. The pool is then awarded to the winning player by the dealer or automated dealer at the table game 12 hosting the winning player.

Once a winning player is selected, the system 10 resets and the interval time started. Once the interval time has elapsed the dealer will re-open betting players.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lottery and table game combination system, said system comprising:
a plurality of table games, each of said table games including a plurality of player positions;
a plurality of interface assemblies, each of said table games having one of said interface assemblies, each of said interface assemblies being programmed to receive one or more betting units from each of said plurality of player positions and associating said betting units with each player position submitting said betting units; and
a database being in communication with each of said interface assemblies, said database being programmed to tally said betting units and forming a pool of said betting units, said database being programmed to randomly select one of said betting units to define a winning bet and communicating said winning bet and said pool to at least said interface assembly positioned on said table game associated with said player position having said winning bet.

2. The lottery and table game combination system according to claim 1, wherein each of said interface assemblies comprises:
a housing;
a processor being mounted within said housing;
an input being mounted on said housing and being electrically coupled to said processor, said input being actuatable to input a number of the betting units associated with each of said player positions at an associated one of said table games.

3. The lottery and table game combination system according to claim 2, wherein said input comprises a touchscreen, said touchscreen displaying said betting units associated with each of said player positions, said touchscreen displaying said winning bet and said player position associated with said winning bet.

4. The lottery and table game combination system according to claim 2, wherein said interface assemblies each further includes a transceiver being mounted within said housing and being electrically coupled to said processor, said transceiver being in wireless communication with said database.

5. The lottery and table game combination system according to claim 3, wherein said interface assemblies each further includes a transceiver being mounted within said housing and being electrically coupled to said processor, said transceiver being in wireless communication with said database.

6. A method of presenting a lottery and table game combination allowing multiple players to selectively play a lottery game while simultaneously playing a table game, said method comprising:
receiving wagers from the players playing a primary game on one of a plurality of table games, each of said table games having a plurality of player positions, each player playing said primary game is associated with at least one of said player positions to define an active position;
presenting a second game to said active positions;
receiving betting units from the players desiring to play said second game;
entering said betting units and an associated player position into one of a plurality of interface assemblies, at least a portion of said betting units being totaled to define a pool, said interface assemblies being in communication with each other, each of said table games having one of said interface assemblies positioned thereon;
assigning each betting unit an identifier such that each betting unit has a unique identifier; and
randomly selecting one of said unique identifiers and awarding said pool the player associated with said unique identifier.

7. The method of presenting a lottery and table game combination as in claim 6, wherein each of said primary games comprising a card based game utilizing one or more deck of cards.

8. The method of presenting a lottery and table game combination as in claim 6, further including said step of presenting said second game to said active positions being for a preselected amount of time.

9. The method of presenting a lottery and table game combination as in claim 6, further including said step of presenting said second game to said active positions being at preselected intervals.

10. The method of presenting a lottery and table game combination as in claim 8, further including said step of presenting said second game to said active positions being at preselected intervals.

11. The method of presenting a lottery and table game combination as in claim 10, said preselected amount of time being less than five minutes, said preselected intervals being greater than 30 minutes.

12. The method of presenting a lottery and table game combination as in claim 11, wherein each of said primary games comprising a card based game utilizing one or more deck of cards.

13. A method of presenting a lottery and table game combination allowing multiple players to selectively play a lottery game while simultaneously playing a table game, said method comprising:
providing a plurality of table games, each of said table games having a plurality of player positions, each of said table games having a primary game associated therewith;
presenting a second game to each of said player positions;
receiving one or more betting units from each of said player positions entering said second game;
entering said betting units and an associated player position into one of a plurality of interface assemblies, each of said table games having one of said interface assemblies positioned thereon;
transmitting said betting units and said associated player positions to a database;
assigning a unique identifier to each betting unit and its associated player position;
combining at least a portion of said betting units to define a pool;
randomly selecting one of said unique identifiers to define a winning position;
transmitting said winning position to at least said interface assembly positioned on said table game associated with said winning position; and
awarding said pool to said player position associated with said winning position.

14. The method of presenting a lottery and table game combination of claim 13, wherein the step of entering said betting units includes said interface assembly comprising a housing, a processor being mounted within said housing, an input being mounted on said housing and being electrically coupled to said processor, said input being actuatable to input a number of the betting units associated with each of said player positions at an associated one of said table games, a transceiver being mounted within said housing and being electrically coupled to said processor, said transceiver being in wireless communication with said database.

15. The method of presenting a lottery and table game combination of claim 14, wherein said input comprises a touchscreen, said touchscreen displaying said winning position and said pool.

16. The method of presenting a lottery and table game combination as in claim 13, wherein each of said primary games comprises a card based game utilizing one or more deck of cards.

17. The method of presenting a lottery and table game combination as in claim 13, further including said step of presenting said second game being for a preselected amount of time.

18. The method of presenting a lottery and table game combination as in claim 13, further including said step of presenting said second game being at preselected intervals.

19. The method of presenting a lottery and table game combination as in claim 17, further including said step of presenting said second game being at preselected intervals.

20. The method of presenting a lottery and table game combination as in claim 19, said preselected amount of time being less than five minutes, said preselected intervals being greater than 30 minutes.
